(19) United States
(12) Patent Application Publication
(10) Pub. No.: US 2025/0003088 A1
(43) Pub. Date: Jan. 2, 2025

(54) Porous Electrode-Supported Electrolyte Membrane and Method for Manufacturing the Same

(71) Applicant: Nippon Telegraph and Telephone Corporation, Tokyo (JP)

(72) Inventors: Sayumi Sato, Musashino-shi, Tokyo (JP); Yuya Uzumaki, Musashino-shi, Tokyo (JP); Akihiro Kono, Musashino-shi, Tokyo (JP); Takeshi Komatsu, Musashino-shi, Tokyo (JP)

(21) Appl. No.: 18/709,763

(22) PCT Filed: Nov. 24, 2021
(86) PCT No.: PCT/JP2021/042950

§ 371 Date: May 13, 2024

(51) Int. Cl. C25B 11/031; C25B 3/26; C25B 9/19; C25B 11/052

(52) U.S. Cl. CPC C25B 11/031; C25B 3/26; C25B 9/19; C25B 11/052

(57) ABSTRACT

A porous electrode-supported electrolyte membrane used in a gas phase reduction device for reducing carbon dioxide includes an electrolyte membrane and a porous reduction electrode bonded to the electrolyte membrane, and a surface of a hole of the porous reduction electrode is coated with a conductive first plating film.

### TECHNICAL FIELD

The present invention relates to a porous electrode-supported electrolyte membrane and a method of manufacturing the porous electrode-supported electrolyte membrane.

### BACKGROUND ART

Technologies for reducing carbon dioxide have attracted attention from a viewpoint of prevention of global warming and stable supply of energy. Devices related to technologies for reducing carbon dioxide include reduction devices using an artificial photosynthesis technology and reduction devices using an electrolytic reduction technology. The artificial photosynthesis technology is a technology for allowing an oxidation reaction of water and a reduction reaction of carbon dioxide to proceed by irradiating an oxidation electrode constituted by a photocatalyst with light. The electrolytic reduction technology is a technology for allowing an oxidation reaction of water and a reduction reaction of carbon dioxide to proceed by applying a voltage between a reduction electrode and an oxidation electrode constituted by metal. The artificial photosynthesis technology using sunlight and the electrolytic reduction technology using electric power from renewable energy have attracted attention as technologies capable of recycling carbon dioxide into hydrocarbons such as carbon monoxide, formic acid, and ethylene, and alcohols such as methanol and ethanol, and have been actively studied in recent years.

In the artificial photosynthesis technology and carbon dioxide electrolytic reduction technology, a reaction system has been used in which a reduction electrode is immersed in an aqueous solution, and carbon dioxide dissolved in the aqueous solution is supplied to the reduction electrode and reduced (see Non Patent Literatures 1 and 2). However, in this method of reducing carbon dioxide, there is a limit to a concentration of carbon dioxide dissolved in the aqueous solution and a diffusion coefficient of carbon dioxide in the aqueous solution, which limits an amount of carbon dioxide supplied to the reduction electrode.

To solve this problem, a research has been conducted for supplying carbon dioxide in a gas phase to a reduction electrode in order to increase the amount of carbon dioxide supplied to the reduction electrode. According to Non Patent Literature 3, by using a reactor having a structure capable of supplying carbon dioxide in a gas phase to a reduction electrode, the amount of carbon dioxide supplied to the reduction electrode is increased, and the reduction reaction of carbon dioxide is promoted.

### CITATION LIST

### Non Patent Literature

Non Patent Literature 1: Satoshi Yotsuhashi, and six others, “CO2 Conversion with Light and Water by GaN Photoelectrode”, Japanese Journal of Applied Physics, 51, 2012, p. 02BP07-1—p. 02BP07-3
Non Patent Literature 2: Yoshio Hori and two others, “Formation of Hydrocarbons in the Electrochemical Reduction of Carbone Dioxide at a Copper Electrode in Aqueous Solution”, Journal of the Chemical Society, 85(8), 1989, p. 2309-p. 2326
Non Patent Literature 3: Qingxin Jia, and two others, “Direct Gas-phase CO2Reduction for Solar Methane Generation Using a Gas Diffusion Electrode with a BiVO4:Mo and a Cu—In—Se Photoanode”, Chemistry Letter, 47, 2018, p. 436-439

### SUMMARY OF INVENTION

### Technical Problem

The reduction reactions of carbon dioxide represented by Formula (1) to Formula (4) proceed in combination with the oxidation reaction of water represented by Formula (5).

CO₂+2H⁺+2e⁻→CO+H₂O (1)

CO₂+2H⁺+2e⁻→HCOOH (2)

CO₂+6H⁺+6e⁻→CH₃OH+H₂O (3)

CO₂+8H⁺+8e⁻→CH₄+2H₂O (4)

2H₂O+4h⁺→O₂+4H⁺ (5)

In a gas phase reduction device for carbon dioxide, an aqueous solution in a reduction tank is removed and the reduction tank is filled with carbon dioxide in a gas phase, but in a case of just filling the reduction tank with carbon dioxide in a gas phase, proton (H⁺) cannot move in the gas phase, and it is therefore necessary to bond an electrolyte membrane and a reduction electrode. Furthermore, in a case of just bonding a plate-like reduction electrode to an electrolyte membrane, carbon dioxide in a gas phase cannot reach an interface between the reduction electrode and the electrolyte membrane, and it is therefore necessary to make the reduction electrode porous so that carbon dioxide in the gas phase can reach the interface between the reduction electrode and the electrolyte membrane. In a case where this porous reduction electrode has a smaller pore diameter, a carbon dioxide diffusion resistance in the electrode becomes larger, and this poses a problem of reduction electrode in efficiency of the reduction reaction of carbon dioxide.

On the other hand, when the pore diameter is too large, an interface length as a reaction field decreases and the reaction resistance increases, and thus the pore diameter is desirably several hundred nm to several hundred μm. As a method of manufacturing a porous metal having such a pore diameter, a metal sintered product is generally produced, but since heat treatment at a high temperature (about 400° C.) is required at the time of sintering, it is difficult to manufacture a metal having a low melting point (for example, indium, tin, lead, or zinc).

The present invention has been made in view of the foregoing, and an object of the present invention is to produce a porous reduction electrode using a material that is easy to produce a porous body structure.

### Solution to Problem

One aspect of the present invention is a porous electrode-supported electrolyte membrane used in a gas phase reduction device for reducing carbon dioxide, and the porous electrode-supported electrolyte membrane includes an electrolyte membrane, and a porous reduction electrode bonded to the electrolyte membrane, in which a surface of a hole of the porous reduction electrode is coated with a conductive first plating film.

One aspect of the present invention is a method of manufacturing a porous electrode-supported electrolyte membrane used in a gas phase reduction device for reducing carbon dioxide, and the method includes a process of forming a conductive first plating film on a surface of a hole of a porous body to produce a porous reduction electrode, and a process of stacking and thermocompression-bonding the porous reduction electrode on an electrolyte membrane.

### Advantageous Effects of Invention

According to the present invention, it is possible to produce a porous reduction electrode using a material that is easy to produce a porous body structure.

### BRIEF DESCRIPTION OF DRAWINGS

FIG. 1 is a cross-sectional view illustrating a configuration example of a porous electrode-supported electrolyte membrane according to the present embodiment.

FIG. 2 is a flowchart illustrating an example of a method of manufacturing the porous electrode-supported electrolyte membrane.

FIG. 3 is a flowchart illustrating an example of a method of manufacturing the porous electrode-supported electrolyte membrane.

FIG. 4 is a view illustrating an example of a state in which thermocompression bonding is performed when a porous electrode-supported electrolyte membrane is manufactured.

FIG. 5 is a view illustrating a configuration example of a gas phase reduction device for carbon dioxide including the porous electrode-supported electrolyte membrane.

### DESCRIPTION OF EMBODIMENTS

Hereinafter, an embodiment of the present invention will be described with reference to the drawings. The present invention is not limited to the embodiment described below, and modifications may be made without departing from the gist of the present invention.

### [Configuration of Porous Electrode-Supported Electrolyte Membrane]

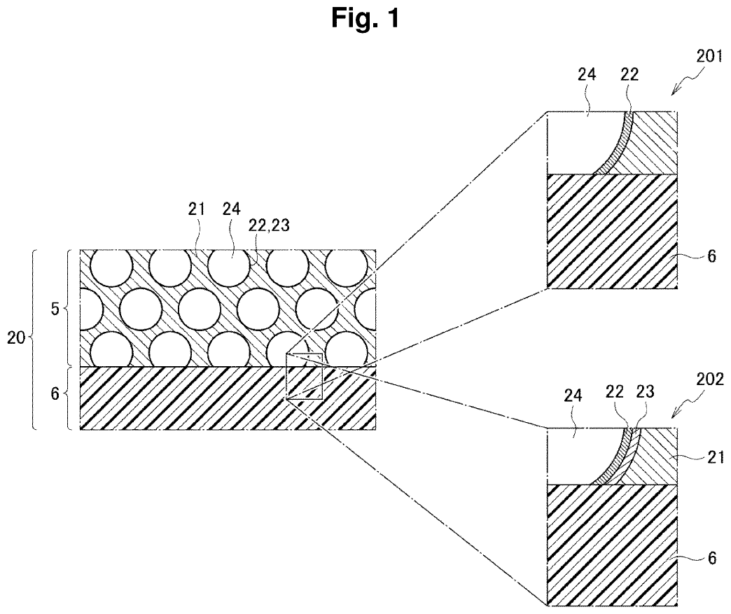

A porous electrode-supported electrolyte membrane 20 according to the present embodiment will be described with reference to a cross-sectional view in FIG. 1. The illustrated porous electrode-supported electrolyte membrane 20 includes an electrolyte membrane 6 and a porous reduction electrode 5 bonded to the electrolyte membrane 6. For example, the porous reduction electrode 5 is directly stacked on the electrolyte membrane 6 and directly bonded by thermocompression bonding.

The porous reduction electrode 5 is configured using a porous body 21 (porous material). The porous body 21 has a plurality of fine holes 24 (pores). Note that the holes 24 of the porous body 21 include communicating pores that allow carbon dioxide to pass through the porous reduction electrode 5 and reach an interface with the electrolyte membrane 6. The holes 24 of the porous body 21 may include independent pores. Further, a shape of a cross section of the hole 24 of the porous body 21 is not limited to a circle illustrated in FIG. 1, and may be various shapes.

For the porous body 21, a conductive material or a non-conductive material may be used. The porous body 21 may be, for example, a porous body containing copper, platinum, gold, silver, indium, palladium, gallium, nickel, tin, or cadmium, or an alloy thereof; a porous body containing silver oxide, copper oxide, copper (II) oxide, nickel oxide, indium oxide, tin oxide, tungsten oxide, tungsten oxide (VI), or copper oxide; or a porous body containing a porous metal complex including a metal ion and an anionic ligand.

Further, the porous body 21 may be made of a synthetic resin material such as polylactic acid (PLA), an acrylate-styrene-acrylonitrile resin (ASA resin), polyethylene (PP), polyethylene terephthalate (PET), an acrylic resin, polyurethane, or nylon.

In the present embodiment, surfaces of the holes 24 of the porous body 21 (porous reduction electrode 5) are coated with a conductive plating film. As illustrated in the enlarged view 201 of FIG. 1, the hole 24 is coated with the plating film 22 (first plating film). The plating film 22 has a function as an electrode material. Note that, for the plating film 22, a conductive material different from the material of the porous body 21 is favorably used.

Further, as illustrated in the enlarged view 202 of FIG. 1, the surface of the hole 24 may be coated with a conductive plating film 23 (second plating film) different from the plating film 22 on the plating film 22. In this case, the plating film 23 has a function as an electrode material.

For the plating films 22 and 23, a conductive material can be used. For example, for the plating films 22 and 23, metal such as copper, platinum, gold, silver, indium, palladium, nickel, tin, lead, or zinc, or an alloy thereof; or metal oxide such as silver oxide, copper oxide, copper (II) oxide, nickel oxide, indium oxide, tin oxide, tungsten oxide, tungsten oxide (VI), or copper oxide can be used.

A film thickness of the plating film 22 is favorably a film thickness that can coat the entire surface of the holes 24 and does not cause cracks. Therefore, the film thickness of the plating film 22 is favorably 0.05 nm to 10 μm. The film thickness of the plating film 23 is also similar to that of the plating film 22.

Note that the plating films 22 and 23 may not coat the surfaces of all the holes 24 of the porous body 21. Further, a part of the surface of the hole 24 may not be coated. That is, the porous reduction electrode 5 may include a portion where the plating films 22 and 23 are not coated, for example, independent pores.

As a method of forming the plating film 22, an electrolytic plating method or an electroless plating method is used in the case where the porous body 21 to be plated is formed using a conductive material. In the case where the porous body 21 to be plated is formed using a non-conductive material, an electroless plating method is used.

Note that, in a case of using a metal species (zinc, iron, gallium, or the like) incapable of forming the plating film 22 in principle by the electroless plating method, or in a case of forming the plating film 22 using a metal species (indium, tin, lead, or the like) not easy to form a plating film on the porous body 21 of a non-conductive material, the metal plating film 22 is formed using a metal species capable of forming a plating film by the electroless plating method, and the plating film 23 is further formed on the surface thereof by the electrolytic plating method.

Further, even in the case where the porous body 21 is formed using a conductive material (for example, metal), in a case where atomic diffusion occurs between the porous body 21 and the plating film as an electrode material, and a composition of the plating film is uncontrollable, the plating film 22 (atomic diffusion preventing film) of a metal species that does not atomically diffuse by the electrolytic plating method needs to be formed on the porous body 21 made of a conductive material, and the plating film 23 having a role as an electrode material needs to be further formed on the surface thereof.

The electrolyte membrane 6 can be, for example, Nafion (registered trademark), Forblue, or Aquivion that is a perfluorocarbon material having a carbon-fluorine skeleton.

### [Method of Manufacturing Porous Electrode-Supported Electrolyte Membrane]

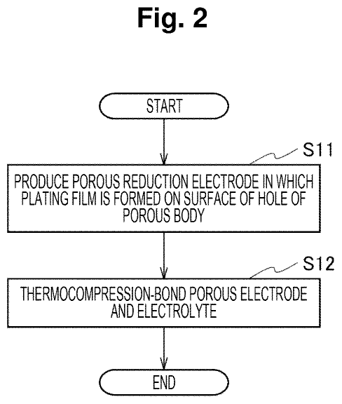

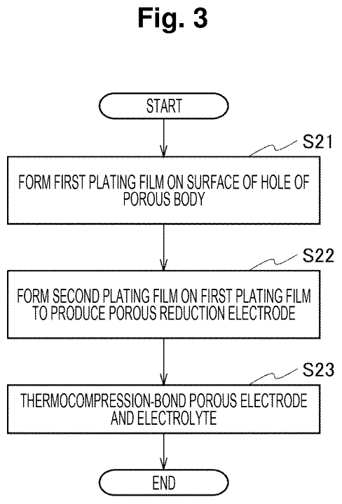

A method of manufacturing the porous electrode-supported electrolyte membrane 20 according to the present embodiment will be described with reference to the flowcharts in FIGS. 2 and 3.

FIG. 2 is an example of a flowchart of a method of manufacturing the porous electrode-supported electrolyte membrane 20 of the enlarged view 201 of FIG. 1. In step S11, the plating film 22 is formed on the surfaces of the holes 24 of the porous body 21 by the electrolytic plating method to produce the porous reduction electrode 5. That is, the holes 24 of the porous body 21 are almost entirely coated with the plating film 22.

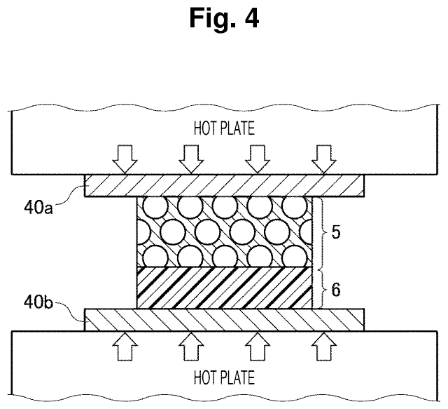

In step S12, the porous reduction electrode 5 is stacked on the electrolyte membrane 6 and thermocompression-bonded by a thermocompression bonding device (for example, a hot press machine). Specifically, as illustrated in FIG. 4, the porous reduction electrode 5 is stacked on the electrolyte membrane 6 and disposed between two copper plates 40a and 40b, and the electrolyte membrane 6 and the porous reduction electrode 5 are thermocompression-bonded together with the copper plates 40a and 40b by the thermocompression bonding device. After the thermocompression bonding, cooling is quickly performed, so that the porous electrode-supported electrolyte membrane 20 in which the electrolyte membrane 6 and the porous reduction electrode 5 are bonded can be obtained.

A heating temperature during thermocompression bonding is favorably equal to or higher than a temperature at which the electrolyte membrane 6 and the porous body 21 (porous reduction electrode 5) can be bonded to each other, and is favorably less than a heat-resistant temperature of the electrolyte membrane 6, a heat-resistant temperature of the porous body 21, and a heat-resistant temperature of the plating film 22. A general heating temperature is 80° C. or more and 180° C. or lower.

FIG. 3 is an example of a flowchart of a method of manufacturing the porous electrode-supported electrolyte membrane 20 of the enlarged view 202 of FIG. 1. In step S21, the plating film 22 (first plating film) is formed on the surfaces of the holes 24 of the porous body 21 by the electroless plating method. That is, the holes 24 of the porous body 21 are almost entirely coated with the plating film 22.

In step S22, the plating film 23 (second plating film) of a conductive material different from the plating film 22 is formed on the surfaces of the holes 24 of the porous body 21 coated with the plating film 22 using the electrolytic plating method. That is, the another plating film 23 is formed on the plating film 22 to produce the porous reduction electrode 5.

In step S23, the porous reduction electrode 5 is stacked on the electrolyte membrane 6 and is thermocompression-bonded by a thermocompression bonding device (for example, a hot press machine). step S23 is similar to the thermocompression bonding processing in step S12 in FIG. 2.

For example, in the case of using a non-conductive material or the like for the porous body 21, a plating film needs to be formed on the surfaces of the holes 24 of the porous body 21 by the electroless plating method, but it is not easy to form a plating film of some metal such as indium by the electroless plating method. Therefore, in FIG. 3, a plating film of a conductive material (for example, copper or the like) that is easily plated by the electroless plating method is formed on the surface of the porous body 21 of a non-conductive material, and then the plating film 23 that serves as an electrode material is further coated using the electrolytic plating method. Further, in the case of using a conductive material for the porous body 21, the manufacturing method illustrated in FIG. 3 may also be applied.

### [Gas Phase Reduction Device (Artificial Photosynthesis)]

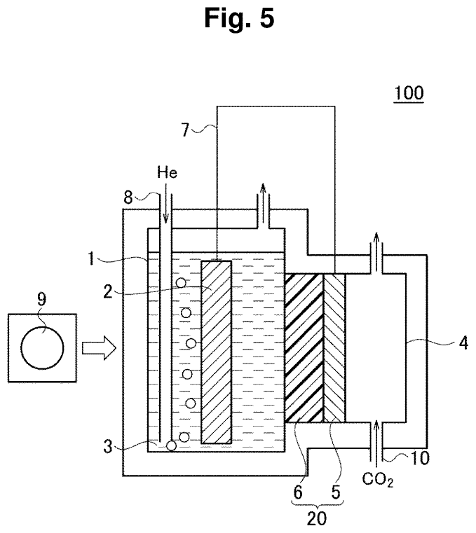

Next, a gas phase reduction device 100 that reduces carbon dioxide will be described with reference to FIG. 5. The gas phase reduction device 100 includes the porous electrode-supported electrolyte membrane 20 of the present embodiment. The gas phase reduction device 100 illustrated in FIG. 5 is a reduction device using an artificial photosynthesis technology for reducing carbon dioxide by light irradiation.

The gas phase reduction device 100 includes an oxidation tank 1 and a reduction tank 4 formed by dividing an internal space in a housing into two spaces by the porous electrode-supported electrolyte membrane 20. That is, the porous electrode-supported electrolyte membrane 20 is disposed between the oxidation tank 1 and the reduction tank 4. The porous electrode-supported electrolyte membrane 20 is disposed with the electrolyte membrane 6 facing the oxidation tank 1 and the porous reduction electrode 5 facing the reduction tank 4.

The oxidation tank 1 is filled with an aqueous solution 3. An oxidation electrode 2 constituted by a semiconductor or a metal complex is inserted into the aqueous solution 3.

For the oxidation electrode 2, for example, a compound exhibiting photoactivity and redox activity, such as a nitride semiconductor, titanium oxide, amorphous silicon, a ruthenium complex, or a rhenium complex can be used. The oxidation electrode 2 is electrically connected to the porous reduction electrode 5 by a conductive wire 7.

As the aqueous solution 3, for example, a potassium hydrogen carbonate aqueous solution, a sodium hydrogen carbonate aqueous solution, a potassium chloride aqueous solution, a sodium chloride aqueous solution, a sodium hydroxide aqueous solution, a potassium hydroxide aqueous solution, a rubidium hydroxide aqueous solution, a cesium hydroxide aqueous solution, or the like can be used. During a reduction reaction, a helium gas is supplied from a tube 8 to the aqueous solution 3.

Carbon dioxide is supplied through a gas input port 10 to the reduction tank 4, and the reduction tank 4 is filled with carbon dioxide or a gas containing carbon dioxide.

A light source 9 is disposed facing the oxidation electrode 2 in order to drive the gas phase reduction device 100. That is, the light source 9 is disposed so that the oxidation electrode 2 is irradiated with light. The light source 9 is, for example, a xenon lamp, a pseudo sunlight source, a halogen lamp, a mercury lamp, sunlight, or the like. The light source 9 may be formed by a combination thereof.

### EXAMPLES OF POROUS ELECTRODE-SUPPORTED ELECTROLYTE MEMBRANE

As the porous electrode-supported electrolyte membrane 20 disposed in the gas phase reduction device 100, Examples 1 to 7 in which the material of the porous body 21 or the plating films 22 and 23 is changed were prepared, and gas phase reduction tests described below were performed. Hereinafter, the porous electrode-supported electrolyte membranes of Examples 1 to 7 will be described.

### Example 1

In Example 1, a copper porous body (porous metal plate) having a thickness of 0.2 mm and a porosity of 73% was used as the porous body 21 of the porous reduction electrode 5.

In step S11 of FIG. 2, the indium plating film 22 was formed on the porous body 21 by the electrolytic plating method, and the porous electrode 5 in which the surface of the porous body 21 was coated with the plating film 22 was prepared. The thickness of the plating film 22 was 1 μm. For the electrolyte membrane 6, Nafion as a proton exchange membrane was used.

In step S12, the porous reduction electrode 5 was stacked on the electrolyte membrane 6 and disposed between the two copper plates 40a and 40b. Then, as illustrated in FIG. 4, this sample was placed between hot press machines, was thermocompression-bonded by applying a pressure in a direction perpendicular to the surface of the porous reduction electrode 5 under a condition of the heating temperature of 100° C., and was left for 3 minutes. Since the temperature at which the film structure of the indium plating film 22 can be maintained is 100° C. or lower, the heating temperature of the thermocompression bonding device was set to 100° C.

Thereafter, the sample was quickly cooled and taken out, and the porous electrode-supported electrolyte membrane in which the electrolyte membrane 6 and the porous reduction electrode 5 are bonded was obtained. An average pore diameter of the porous reduction electrode 5 after thermocompression bonding was 97 μm.

### Example 2

In Example 2, the polypropylene porous body 21 having the thickness of 0.1 mm and the porosity of 87% was used as the porous body 21 of the porous reduction electrode 5.

In step S21 in FIG. 3, the surface of the hole 24 of the polypropylene porous body 21 was coated with the copper plating film 22 using the electroless plating method. The thickness of the plating film 22 was 1 μm. Since polypropylene is a non-conductive material, it is necessary to form the plating film by the electroless plating method, but it is not easy to form the indium plating film by the electroless plating method. For this reason, first, the copper plating film 22 was formed on the polypropylene porous body 21 by the electroless plating method.

In step S22, the copper plating film 22 formed in step S22 was coated with the indium plating film 23 using the electrolytic plating method to prepare the porous reduction electrode 5. The thickness of the plating film 23 was 1 μm.

In step S23, similarly to step S12 of Example 1, the electrolyte membrane 6 and the porous reduction electrode 5 were thermocompression-bonded to prepare the porous electrode-supported electrolyte membrane 20. For the electrolyte membrane 6, Nafion as a proton exchange membrane was used, similarly to Example 1. The average pore diameter of the porous reduction electrode after thermocompression bonding was 97 μm.

### Example 3

In Example 3, a copper porous body having the thickness of 0.2 mm and the porosity of 73% was used as the porous body 21 of the porous reduction electrode 5. The surfaces of the holes 24 of the porous body 21 were coated with the tin plating film 22 using the electrolytic plating method to prepare the porous electrode-supported electrolyte membrane 20. The thickness of the plating film 22 was 1 μm. The other conditions are all similar to those in Example 1. The average pore diameter of the porous reduction electrode 5 after thermocompression bonding was 97 μm.

### Example 4

In Example 4, a polypropylene porous body having the thickness of 0.1 mm and the porosity of 87% was used as the porous body 21 of the porous reduction electrode 5. The surfaces of the holes 24 of the porous body 21 were coated with the copper plating film 22 using the electroless plating method. The thickness of the plating film 22 was 1 μm.

Since polypropylene is a non-conductive material, it is necessary to form the plating film by the electroless plating method, but it is not easy to form the tin plating film by the electroless plating method. For this reason, first, the copper plating film 22 was formed on the polypropylene porous body 21 by the electroless plating method.

Thereafter, the copper plating film 22 was coated with the tin plating film 23 using the electrolytic plating method. The thickness of the plating film 23 was 1 μm. The other conditions are all similar to those in Example 2. An average pore diameter of the porous reduction electrode 5 after thermocompression bonding was 97 μm.

### Example 5

In Example 5, polypropylene having the thickness of 0.1 mm and the porosity of 87% was used as the porous body 21 of the porous reduction electrode 5. The surfaces of the holes 24 of the porous body 21 were coated with the copper plating film 22 using the electroless plating method. The thickness of the plating film 22 was 1 μm. The other conditions are all similar to those in Example 1. The average pore diameter of the porous reduction electrode 5 after thermocompression bonding was 98 μm.

### Example 6

In Example 6, the copper porous body 21 having the thickness of 0.2 mm and the porosity of 74% was used as the porous body 21 of the porous reduction electrode 5. The surfaces of the holes 24 of the porous body 21 were coated with the nickel plating film 22 using the electrolytic plating method. The thickness of the plating film 22 was 1 μm. Thereafter, the nickel plating film 22 was coated with the gold plating film 23 using the electrolytic plating method. The thickness of the plating film 23 was 1 μm. The other conditions are all similar to those in Example 2. An average pore diameter of the porous reduction electrode 5 after thermocompression bonding was 97 μm.

### Example 7

In Example 6, polypropylene having the thickness of 0.1 mm and the porosity of 87% was used as the porous body 21 of the porous reduction electrode 5. The surfaces of the holes 24 of the porous body 21 were coated with the gold plating film 22 using the electroless plating method. The thickness of the plating film 22 was 1 μm. The other conditions are all similar to those in Example 1. The average pore diameter of the porous reduction electrode 5 after thermocompression bonding was 98 μm.

### [Electrochemical Measurement and Measurement of Gas/Liquid Generation Amount]

Each of the porous electrode-supported electrolyte membranes 20 of Examples 1 to 7 was attached to the gas phase reduction device 100 in FIG. 5, and the following reduction reaction test was performed.

The oxidation tank 1 was filled with the aqueous solution 3. As the aqueous solution 3, a potassium hydroxide aqueous solution of 1.0 mol/L was used.

The oxidation electrode 2 was disposed in the oxidation tank 1 so as to be immersed in the aqueous solution 3. As the oxidation electrode 2, a semiconductor photoelectrode prepared as follows was used. A semiconductor photoelectrode was prepared by performing epitaxial growth of a thin film of GaN and AlGaN as an n-type semiconductor in this order on a sapphire substrate, vacuum-depositing Ni on the AlGaN, and heat-treating the resulting product to form a co-catalyst thin film of NiO.

As the light source 9, a high pressure xenon lamp of 300 W (that cuts wavelength of 450 nm or more, and has illuminance of 6.6 mW/cm²) was used. The light source 9 was fixed such that the surface of the oxidation electrode 2 on which an oxidation co-catalyst is formed was irradiated with light. A light irradiation area of the oxidation electrode 2 was set to 2.5 cm².

Helium (He) was caused to flow into the oxidation tank 1 from the tube 8, and carbon dioxide (CO₂) was caused to flow into the reduction tank 4 through the gas input port 10 at the flow rate of 5 ml/min. In the case of Example 1, in this system, a reduction reaction of carbon dioxide can proceed at a three-phase interface constituted by [electrolyte membrane-copper-carbon dioxide in a gas phase] in the porous electrode-supported electrolyte membrane 20.

The oxidation tank 1 and the reduction tank 4 were sufficiently replaced with helium and carbon dioxide, and then the oxidation electrode 2 was uniformly irradiated with light using the light source 9. The irradiation with light causes electrons to flow between the oxidation electrode 2 and the porous reduction electrode 5.

A current value between the oxidation electrode 2 and the porous reduction electrode 5 at the time of light irradiation was measured with an electrochemical measurement device (Model 1287 Potentiogalvanostat manufactured by Solartron). Further, gas and liquid in the oxidation tank 1 and the reduction tank 4 were collected at any time during the light irradiation, and reaction products were analyzed using a gas chromatograph, a liquid chromatograph, and a gas chromatograph mass spectrometer. As a result, it was confirmed that oxygen was generated in the oxidation tank 1, and hydrogen and/or carbon dioxide reduction products (carbon monoxide, formic acid, methane, methanol, ethanol, ethylene, and the like) were generated in the reduction tank 4.

Note that the test results of Examples 1 to 7 will be described below together with test results of Comparative Examples 1 and 2.

### COMPARATIVE EXAMPLES

In Comparative Examples 1 and 2, a porous electrode-supported electrolyte membrane using a porous reduction electrode (porous body) on which no plating film is not formed was prepared. Comparative Examples 1 and 2 were disposed as the porous electrode-supported electrolyte membrane 20 of the gas phase reduction device 100 of FIG. 5, and similar tests to those of Examples 1 to 7 were performed.

### Comparative Example 1

In Comparative Example 1, the copper porous body 21 having the thickness of 0.2 mm and the porosity of 73% was used as the porous reduction electrode 5. The porous reduction electrode 5 was thermocompression-bonded to the electrolyte membrane 6 similarly to S12 of Example 1 to prepare the porous electrode-supported electrolyte membrane 20. The other conditions are all similar to those in Example 1. The average pore diameter of the porous reduction electrode 5 after thermocompression bonding was 98 μm.

### Comparative Example 2

In Comparative Example 2, the gold porous body 21 having the thickness of 0.2 mm and the porosity of 73% was used as the porous reduction electrode 5. The porous reduction electrode 5 was thermocompression-bonded to the electrolyte membrane 6 similarly to S12 of Example 1 to prepare the porous electrode-supported electrolyte membrane 20. The other conditions are all similar to those in Example 1. The average pore diameter of the porous reduction electrode after thermocompression bonding was 98 μm.

### [Evaluation of Examples and Comparative Examples]

Next, test results of Examples 1 to 7 and Comparative Examples 1 and 2 will be described. Table 1 illustrates Faraday efficiency of each carbon dioxide reduction reaction after 1 hour for Examples 1 to 7 and Comparative Examples 1 and 2. In Table 1, the Faraday efficiency is described separately for the reduction reactions to carbon monoxide (CO) and to formic acid (HCOOH), which are main carbon dioxide reduction reactions. The other carbon dioxide reduction reactions were less than 5% in total.

TABLE 1

| | | | | | | Faraday efficiency | |
|---|---|---|---|---|---|---|---|
| | | | | | Volume | (%) of carbon | |
| | | | | | ratio | dioxide reduction | |
| | | | | Pore | (%) of | reaction | |
| | Porous | Plating | Plating | diameter | electrode | after 1 hour | |
| | body 21 | film 22 | film 23 | (μm) | material | CO | HCOOH |
| Example 1 | Copper | Indium | — | 97 | 5.4 | — | 41 |
| Example 2 | Polypropylene | Copper | Indium | 97 | 11 | — | 40 |
| Example 3 | Copper | Tin | — | 97 | 5.4 | — | 40 |
| Example 4 | Polypropylene | Copper | Tin | 97 | 11 | — | 40 |
| Example 5 | Polypropylene | Copper | — | 98 | 12 | — | 30 |
| Example 6 | Copper | Nickel | Gold | 97 | 5.3 | 39 | — |
| Example 7 | Polypropylene | Gold | — | 98 | 12 | 40 | — |
| Comparative | Copper | — | — | 98 | 100 | — | 30 |
| Example 1 | | | | | | | |
| Comparative | Gold | — | — | 98 | 100 | 39 | — |
| Example 2 | | | | | | | |

As represented by Formula (6), the Faraday efficiency indicates a ratio of a current value used in each reduction reaction to a current value of a current flowing between electrodes at the time of light irradiation or voltage application.

$$The Faraday efficiency [ \% ] of each reduction reaction = ( a charge \\ consumed in each reduction reaction ) / ( a charge flowing between \\ the oxidation electrode and the reduction electrode ) \times 100 \qquad ( 6 )$$

Here, the “charge consumed in each reduction reaction” in Formula (6) can be obtained by converting a measured value of a reaction product amount of each reduction reaction into the charge necessary for the reduction reaction. When the reaction product amount of each reduction reaction is A [mol], the number of electrons required for the reduction reaction is Z, and a Faraday constant is F [C/mol], the “charge consumed in each reduction reaction” is calculated using Formula (7).

$$The charge [ C ] consumed in each reduction reaction = A \times Z \times F \qquad ( 7 )$$

Examples 1 to 4 in which the Faraday efficiency of the reduction reaction from carbon dioxide to formic acid after 1 hour was main are compared with Comparative Example 1. It was found that the Faraday efficiency was higher in Examples 1 to 4 than in Comparative Example 1, and controllability was improved. The reason for this is considered that the metal species (indium, tin, or lead) known as a metal species useful for the carbon dioxide reduction reaction to formic acid is difficult to be porous from the viewpoint of processability, but the porous reduction electrode 5 in which indium or tin is plated on the surfaces of the holes 24 of the porous body 21 made of a different material was used.

Further, Example 5 is compared with Comparative Example 1. Although the Faraday efficiency in the reduction reaction from carbon dioxide to formic acid is similar between the porous metal in which the copper plating film 22 is formed on the polypropylene porous body 21 in Example 5 and the porous metal produced from copper alone in Comparative Example 1, a volume ratio of copper (electrode material) can be significantly reduced in Example 5. As represented in Formula (8), the volume ratio is calculated by setting the volume obtained by removing a void portion of the holes 24 from the entire porous reduction electrode 5 as a denominator, and setting the volume of the portion of the electrode material of the porous reduction electrode 5 as a molecule.

$$The volume ratio [ \% ] = ( the volume of the electrode material ) / \qquad ( 8 )$$

$$( the volume of the entire porous reduction electrode -$$

$$the volume of the pore void portion ) \times 100$$

Further, Examples 6 and 7 are compared with Comparative Example 2. Although the Faraday efficiency in the reduction reaction from carbon dioxide to carbon monoxide is similar between the porous metal obtained by forming the gold plating film on the polypropylene or copper porous body 21 of Example 6 or 7 and the porous metal produced from gold alone of Comparative Example 2, the volume ratio of gold (electrode material) can be significantly reduced in Example 6 or 7.

From the fact, it was found that by plating the surfaces of the holes 24 of the inexpensive porous body 21 with an expensive electrode metal material, similar performance to that of a metal porous body manufactured from an expensive metal alone can be realized by a low-cost material.

Further, by adopting a non-conductive material (polypropylene in Example 2, 4, 5, or 7) different from the electrode material as the porous body 21, the degree of freedom and controllability of the porous body structure can be enhanced, and in addition, the porous body 21 can be efficiently manufactured using a 3D printer or the like. Therefore, design and manufacturing process of the porous body 21 can be simplified. In Examples, the polypropylene porous body 21 was used, but a non-conductive material such as another synthetic resin can also be used for the porous body 21.

As described above, the porous electrode-supported electrolyte membrane 20 of the present embodiment is a porous electrode-supported electrolyte membrane used in a gas phase reduction device that reduces carbon dioxide, and includes the electrolyte membrane 6 and the porous reduction electrode 5 bonded to the electrolyte membrane 6, and the surface of the hole 24 of the porous reduction electrode 5 is coated with the conductive plating film 22.

As a result, in the present embodiment, the number of metal species that can be used for the porous reduction electrode 5 can be increased, and the controllability of the Faraday efficiency of the reduction reaction of carbon dioxide can be improved. For example, in the present embodiment, a metal porous material having a low melting point can be manufactured.

Further, since the surfaces of the holes 24 of the porous body 21 are thinly coated with the plating film (electrode material), the amount of the metal material to be used can be greatly reduced, and the amount of the electrode material to be used can be reduced to reduce material cost. In particular, the material cost can be greatly reduced in the present embodiment as compared with the case where the porous body 21 is manufactured only with an expensive metal alone (for example, gold or platinum).

Further, by coating the surfaces of the holes 24 of the porous body 21 with a conductive plating film, a material different from the electrode material (for example, a synthetic resin such as plastic) can be adopted as the material of the porous body 21. As a result, the porous body 21 can be efficiently and precisely manufactured using a 3D printer or the like, and the design and manufacturing process of the porous body 21 can be simplified, in addition to the high degree of freedom and controllability of the porous body structure.

As described above, in the present embodiment, for the metal with which a porous body is difficult to manufacture by a general technique from the viewpoint of processability, the surfaces of the holes 24 of the porous body 21 made of a different material is coated with the metal as a plating film, whereby the porous metal can be realized, and the controllability of a gas phase reduction of carbon dioxide can be improved. Further, by using a plating film for the metal that can be made porous, the amount of electrode material required can be reduced, and the material cost can be reduced.

The present invention is not limited to the above embodiment, and various modifications can be made within the scope of the spirit of the present invention.

### REFERENCE SIGNS LIST

20 Porous electrode-supported electrolyte membrane
21 Porous body
22 Plating film (first plating film)
23 Plating film (second plating film)
24 Hole
5 Porous reduction electrode
6 Electrolyte membrane

1. A porous electrode-supported electrolyte membrane used in a gas phase reduction device for reducing carbon dioxide, the porous electrode-supported electrolyte membrane comprising:
an electrolyte membrane; and
a porous reduction electrode bonded to the electrolyte membrane, wherein
a surface of a hole of the porous reduction electrode is coated with a conductive first plating film.

2. The porous electrode-supported electrolyte membrane according to claim 1, wherein
the surface of the hole is coated with a conductive second plating film different from the first plating film on the first plating film.

3. The porous electrode-supported electrolyte membrane according to claim 1, wherein
a porous body of a non-conductive material is used for the porous reduction electrode.

4. The porous electrode-supported electrolyte membrane according to claim 1, wherein
a porous body of a conductive material is used for the porous reduction electrode, and
the first plating film is different from the conductive material of the porous body.

5. A method of manufacturing a porous electrode-supported electrolyte membrane used in a gas phase reduction device for reducing carbon dioxide, the method comprising:
a process of forming a conductive first plating film on a surface of a hole of a porous body to produce a porous reduction electrode; and
a process of stacking and thermocompression-bonding the porous reduction electrode on an electrolyte membrane.

6. The method of manufacturing a porous electrode-supported electrolyte membrane according to claim 5, wherein
the processing of producing the porous reduction electrode includes a process of forming a conductive second plating film different from the first plating film on the first plating film.

7. The porous electrode-supported electrolyte membrane according to claim 2, wherein
a porous body of a non-conductive material is used for the porous reduction electrode.

8. The porous electrode-supported electrolyte membrane according to claim 2, wherein
a porous body of a conductive material is used for the porous reduction electrode, and
the first plating film is different from the conductive material of the porous body.
